(19) United States
(12) Patent Application Publication
(10) Pub. No.: US 2004/0092259 A1
(43) Pub. Date: May 13, 2004

(54) Method for establishing a list of neighbouring cells in a mobile radiocommunication system

(76) Inventors: Patrick Blanc, Issy Les Moulineaux (FR); Pascal Treillard, Palaiseau (FR)

Correspondence Address: Sughrue Mion, 2100 Pennsylvania Avenue NW, Washington, DC, 20037-3213, US

(21) Appl. No.: 10/473,157

(22) PCT Filed: Mar. 21, 2002
(86) PCT No.: PCT/FR02/00997

(30) Foreign Application Priority Data
Mar. 30, 2001 (FR) 10/04403

(51) Int. Cl. H04Q 7/20; H04J 3/16; H04J 3/22

(52) U.S. Cl. 455/432.1; 455/436; 455/446; 455/450; 370/466

(57) ABSTRACT

A method of drawing up a list of neighboring cells for a mobile station in a cellular mobile radio system, which method is essentially characterized in that, said system including a plurality of separate networks, said list is an optimized list, drawn up in the access network of the server network of said mobile station, on the basis of a list of networks authorized for said mobile station received from the core network of said server network.

The present invention relates generally to mobile radio systems.

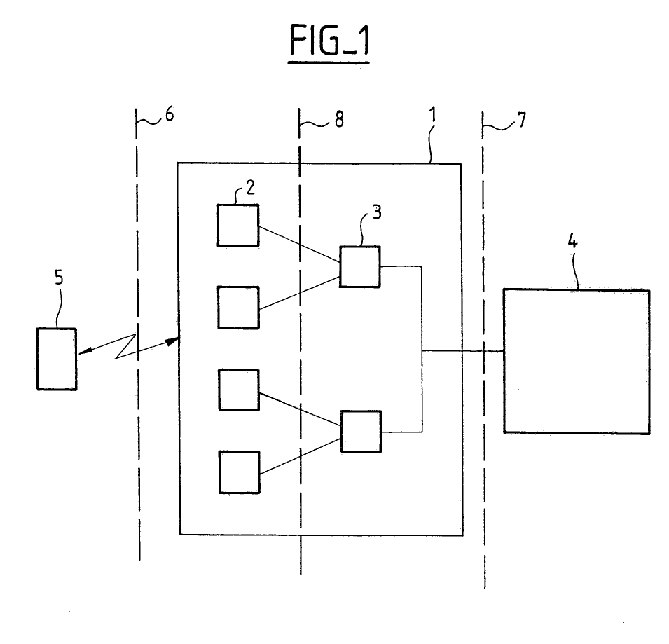

FIG. 1 outlines the architecture of systems of this kind. As a general rule, a system of this kind essentially includes:

an access network (AN) 1, formed of base stations 2 and base station controllers 3, and

a core network (CN) 4.

The radio access network 1 communicates with mobile stations 5 via a radio interface 6 and with the core network via an interface 7. Within the radio access network, the base stations communicate with the base station controllers via an interface 8.

The core network 4 communicates with the radio access network via the interface 7 and with external networks that are not shown specifically.

As a general rule, systems of this kind have a cellular architecture and handover (intercellular transfer) techniques are provided for transferring calls from cell to cell as and when required. In the conventional mobile-assisted handover (MAHO) technique, a mobile station carries out radio measurements on cells neighboring its server cell and reports the results of these radio measurements to the network, in order to facilitate the making of the handover decision by the network.

A list of the neighboring cells on which measurements are to be effected is usually sent to the mobile stations by the network, generally in a broadcast mode. The list is generally defined in the portion of the network that is in contact with the mobile stations via the radio interface, namely the access network (AN). The access network is generally configured with a list of this kind by network operation and maintenance (O&M) means, which themselves determine the list as a function of the configuration of the system.

As a general rule, systems of the above kind include a plurality of separate public land mobile networks (PLMN) whose coverage areas may or may not overlap and which are operated independently of each other by different operators. In particular, this enables expansion of the geographical coverage and/or services offered.

To enable transfers between PLMNs, if necessary, i.e. handovers between cells belonging to different networks, the list of neighboring cells can then include cells belonging to networks other than the network to which the mobile station is connected, which is referred to below as the “server” network.

A transfer from a server PLMN to another PLMN can be effected only if it has been authorized, which necessitates a knowledge of information such as information relating to roaming agreements between the operators and the user's type of contract. This information is not usually available in the access network, but only in the core network (CN), which is the portion of the network in which such information is generally centralized. For this reason, the list of neighboring cells is usually drawn up without reference to this information, and access rights are verified subsequently.

This being the case, a mobile station may be called upon to effect radio measurements on a neighboring cell belonging to a network other than its server network, even though it is not authorized to access that other network thereafter. This does not represent optimum use of the signaling resources at the radio network and of processing resources in the network, and therefore degrades system performance.

Moreover, in systems of the above kind, technical advances distinguish between second generation technologies, in particular of the Global System for Mobile communication (GSM) type, and third generation technologies, in particular of the Universal Mobile Telecommunication System (UMTS) type.

In systems of the GSM type, the radio access network is called the base station subsystem (BSS), a base station is called a base transceiver station (BTS), and the core network is called the network subsystem (NSS). The NSS essentially contains network entities or nodes such as mobile switching centers (MSC). The radio interface is called the Um interface, the interface 7 is called the A interface, and the interface 8 is called the Abis interface.

The GSM system is governed by standards and for more information reference can be made to the corresponding standards published by the corresponding standardization organizations.

In systems of the UMTS type, the radio access network is called the UMTS terrestrial radio access network (UTRAN), a base station is called a Node B, a base station controller is called a radio network controller (RNC), and a mobile station is called a user equipment (UE). The radio interface is called the Uu interface, the interface 7 is called the Iu interface, the interface 8 is called the Iub interface, and there is also an interface between radio network controllers called the Iur interface. The combination of an RNC and the Nodes B that it controls is called the radio network subsystem (RNS).

The UMTS access network differs essentially from the GSM access network through the introduction of improved radio access technologies, based in particular on the use of wideband code division multiple access (W-CDMA) techniques. There are also two modes of operation, a frequency domain duplex (FDD) mode and a time domain duplex (TDD) mode.

The UMTS is also governed by standards and for more information reference can be made to the corresponding standards published by the corresponding standardization organizations.

The same network or PLMN can contain cells using second generation radio access technologies and cells using third generation radio access technologies. This occurs in particular when third generation radio access technologies are introduced into an existing second generation infrastructure. Furthermore, the services offered may not be uniform within the same network or PLMN, for reasons other than the type of radio access technology available.

The concept of authorizing a transfer between PLMNs therefore becomes relatively complex if all possible situations are to be taken into account. For example, it may happen that a network or PLMN is authorized for the UMTS technology (because there is a UMTS roaming agreement between the operators concerned), but not for the GSM technology (because there is no GSM roaming agreement between the operators). Situations in which a mobile station runs the risk of being caused to effect radio measurements on a neighboring cell but is not authorized to access the cell thereafter can then occur relatively frequently, and the overall performance of the system can then be further degraded.

Furthermore, third generation radio access technologies of the UMTS type necessitate the use of a particular transmission mode known as the compressed mode to enable a mobile station to effect radio measurements on a neighboring cell having a frequency different from that of its server cell.

Thus the compressed mode can be used, for example, in the case of a server cell using a radio access technology of the UMTS type and in the case of a neighboring cell using a radio access technology of the GSM type, or in the case of a server cell using the FDD mode and a neighboring cell using the TDD mode, or vice versa.

The compressed mode itself degrades performance because the information transmitted is compressed, i.e. transmitted over a time period shorter than that necessary in the normal mode, in order to create transmission gaps during which the mobile station can effect the necessary radio measurements.

As previously indicated, a mobile station may have to effect measurements on a neighboring cell belonging to a network other than its server network, which it is not authorized to access thereafter. If the compressed mode must be used for this, performance is degraded without benefit.

Moreover, the compressed mode parameters (such as in particular the duration and/or the frequency of transmission gaps) may differ according to the type of radio access technology used in the neighboring cell on which measurements are to be effected in this case, just as the list of neighboring cells cannot be constructed optimally (as previously explained), the compressed mode parameters cannot be configured optimally.

To avoid the various drawbacks mentioned above, it would be possible to duplicate in the access network the information necessary for verifying access rights available in the core network. Apart from the fact that this is not an economic solution, such a solution is not optimum either, because it significantly increases the load on the operation and maintenance means, especially as the information concerned may become relatively complex, for the reasons previously explained.

It is also possible that the server network may indicate to the mobile stations, for each cell from the list of neighboring cells, the identity of the network or PLMN to which it belongs. On the basis of this information, and as a function of the user's contract data (available in particular in the subscriber identity module (SIM) card associated with the mobile station), the mobile station could then select from the list the cells belonging to networks to which the user has access, and effect measurements only on those cells. However, such a solution is not adequate or optimum either, in particular because the mobile has no knowledge of information relating to roaming agreements between operators.

A need therefore exists for a solution avoiding the above drawbacks, or more generally a solution for optimizing handover in the above systems.

Thus the present invention provides a method of drawing up a list of neighboring cells for a mobile station in a cellular mobile radio system, which method is essentially characterized in that, said system including a plurality of separate networks, said list is an optimized list, drawn up in the access network of the server network of said mobile station, on the basis of a list of networks authorized for said mobile station received from the core network of said server network.

According to another feature, in the case of networks including different types of cells in which different services or different radio access technologies are available, said list of authorized networks further indicates authorized services or radio access technologies for an authorized network.

According to another feature, the radio access technologies include second generation radio access technologies and third generation radio access technologies.

According to another feature, the authorized networks and/or services or radio access technologies are a function of roaming agreements between operators.

According to another feature, the authorized networks and/or services or radio access technologies are also a function of the user's type of contract.

According to another feature, the authorized networks are classified in an order of preference for the user.

According to another feature, said access network uses second generation radio access technologies.

According to another feature, in a system of the GSM type, said access network is of the base station subsystem (BSS) type.

According to another feature, said access network uses third generation technologies.

According to another feature, in a system of the UMTS type, said access network is of the radio network subsystem (RNS) type.

According to another feature, said optimized list is sent to the mobile station on a common channel.

According to another feature, said optimized list is sent to the mobile station on a dedicated channel.

The invention further provides a mobile radio system including means for implementing the above method.

The invention further provides mobile radio system equipment including means for implementing the above method.

The invention further provides a mobile station including means for implementing the above method.

Other objects and features of the present invention will become apparent on reading the following description of one embodiment of the invention, which is given with reference to the accompanying drawings, in which:

FIG. 1 summarizes the general architecture of a mobile radio system, and

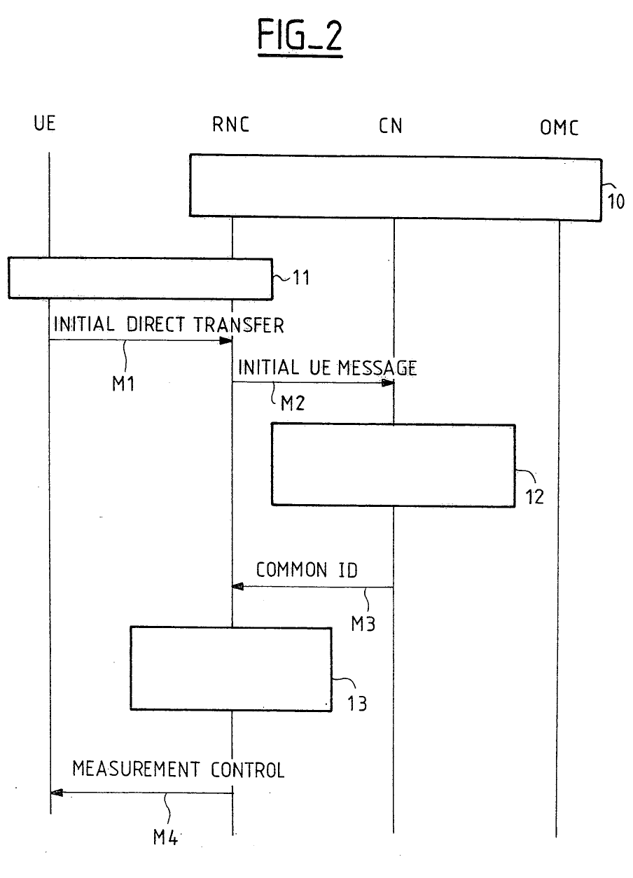

FIG. 2 is a diagram illustrating one example of a method in accordance with the invention.

An object of the present invention is thus to optimize mobile-assisted handover in a cellular mobile radio system in a network comprising a plurality of separate networks or PLMNs.

Essentially, in accordance with the invention, the list of neighboring cells is an optimized list, drawn up in the access network of the server network of the mobile station, on the basis of a list of networks authorized for the mobile station received from the core network of the server network.

In the case of networks comprising different types of cells in which different services or different radio access technologies are available, said list of authorized networks advantageously further indicates the authorized services or radio access technologies for an authorized network.

The various radio access technologies can in particular include second generation radio access technologies and third generation radio access technologies.

In particular, the authorized networks and/or services or radio access technologies are a function of roaming agreements between operators.

The authorized networks and/or services or radio access technologies can further be a function of the user's type of contract.

The authorized networks are advantageously classified in an order of preference for the user.

One example of said access network uses second generation radio access technologies. In particular, in a system of the GSM type, said access network is of the base station sub-system (BSS) type.

Another example of said access network uses third generation radio access technologies. In particular, in a system UMTS of the type, said access network is of the radio network subsystem (RNS) type.

In one example, said optimized list is sent to the mobile station on a common channel.

In another example, said optimized list is sent to the mobile station on a dedicated channel.

In particular, the access network AN can draw up an optimized list of neighboring cells with which it was configured (by means such as operation and maintenance means, for example) and information relating to the authorized networks and services or radio access technologies received from the core network CN.

The access network then sends the optimized list of neighboring cells it has drawn up to the mobile station. If the list is specific to each user, i.e. if it was drawn up taking account also of the user's type of contract, it is preferably sent on a dedicated channel. If the list is common to all users, i.e. if it was not drawn up allowing also for the user's type of contract, it can be sent on a common channel, the contract type then being taken into account by the mobile station and/or the associated SIM card.

The access network in which the optimized list of neighboring cells is drawn up in this way can itself use second generation radio access technologies or third generation radio access technologies.

One embodiment of a method according to the invention is described next, by way of example, and corresponds more particularly to third generation radio access technology of the UMTS type.

The method is described with reference to FIG. 2 and comprises steps involving user equipment (UE), radio network controller (RNC), and core network (CN) entities, as briefly described in the introduction for a system of the UMTS type, and an operation and maintenance center (OMC) entity corresponding to operation and maintenance means, also as explained in the introduction.

The method shown includes a preliminary step 10 during which the RNC is configured with a list of neighboring cells for each cell that it controls. For each neighboring cell, the network or PLMN to which it belongs is indicated, in particular by means of the network identifier PLM ID, and the type of radio access technology (RAT) used in the cell is also indicated.

Thus each RNC is configured with a list of neighboring cells for each cell that it controls. Furthermore, in the case of macrodiversity connections using separate RNCs, namely a serving RNC (SRNC) and a controlling RNC (CRNC), the RNC concerned is the SRNC, and a CRNC can also send a list of neighboring cells to the SRNC via the Iur interface.

The RNC that controls a given Node B is known as the controlling radio network controller (CRNC) and is therefore connected to the Node B via the Iub interface. The CRNC has the role of load control and radio resource control and allocation for the Nodes B that it controls.

For a given call relating to a given user equipment UE, an RNC known as the serving radio network controller (SRNC) is connected to the core network CN via the Iu interface. The SRNC has a control role for the call concerned, including functions for adding or dropping radio links (in accordance with the macrodiversity transmission technique), monitoring parameters liable to change during a call, such as bit rate, power, spreading factor, etc.

The method according to the invention can be implemented on setting up a radio resource control (RRC) connection with a UE, as represented by an initial step 11. According to the RRC protocol, as defined in the standard 3G TS 25.331, the following messages are sent on setting up this kind of connection:

an INITIAL DIRECT TRANSFER message M1, which is sent from the UE to the RNC, and

an INITIAL UE MESSAGE M2, which is sent from the RNC to the CN.

When the CN receives the message M2, a step 12 is executed in the CN, including in particular interrogation of mobile user databases, such as in particular a home location register (HLR) and a visitor location register (VLR), to obtain a list of networks authorized for the UE concerned.

A message M3 is then sent from the CN to the RNC, containing a list of networks authorized for the UE concerned.

The authorized networks are advantageously classified in an order of preference for the UE.

For each authorized network, the type of service and/or technology authorized for the UE is advantageously indicated (for example: GSM, UMTS-FDD, UMTS-TDD, etc.).

Thus the message M3 can contain the following information, for example:

the identity of the UE, in particular its mobile subscriber identity (IMSI),

a list of authorized and preferred networks or PLM (with the authorized technology type for each of them),

a list of authorized networks or PLM (with the authorized technology type for each of them).

In this information, the authorized networks or PLMN can equally be identified by their identifier PLMN ID.

The message M3 can advantageously be the COMMON ID message used in accordance with the protocol for communication between the CN and the RNC.

On receiving the message M3, the RNC draws up an optimized list of neighboring cells (step 13). In the example shown, the optimized list is based on the list of neighboring cells with which it was configured and on information contained in the message M3. In this example, the authorized radio access technology is indicated for each authorized network. Furthermore, in this example, the authorized networks are classified in an order of preference for the user. The mobile station can then report results of measurements only on neighboring cells belonging to preferred networks, which further optimizes performance.

The RNC can also take account of other criteria in drawing up the optimized list of neighboring cells, such as, in particular:

measurement results previously reported by the UE,

radio bearer (RAB) parameters,

limitations on signaling or UE capacity,

constraints on the use of compressed mode,

etc.

If the compressed mode must be used to enable radio measurements on one of the cells from the optimized list (depending on the technology used in that cell), the RNC can then configure the compressed mode parameters accordingly.

The optimized list of neighboring cells can be transmitted to the UE in a message M4, such as in particular the MEASUREMENT CONTROL message used in the RRC protocol.

It should be noted that the figure described above merely represents one schematic example of the method, to the degree necessary to understand the present invention, and without going into more details of the signaling protocols or methods, which can rely on principles that are conventional in such systems.

It should further be noted that this figure corresponds to only one embodiment, corresponding in this instance to radio access technologies of the UMTS type, and to specific examples of signaling message as used in this type of radio access technology, but that other examples of signaling messages and/or other types of radio access technology could of course be used without departing from the scope of the present invention.

The present invention further provides, in addition to a method of the above kind, a mobile radio system, a mobile radio network, and a mobile station incorporating means for implementing the method.

Those means can operate in accordance with the method as previously described; their particular implementation representing no particular difficulty for the person skilled in the art, such means do not need to be described here in more detail than by stating their function, as previously.

1. A method of drawing up a list of neighboring cells for a mobile station in a cellular mobile radio system, which method is characterized in that, said system including a plurality of separate networks, said list is an optimized list, drawn up in the access network of the server network of said mobile station, on the basis of a list of networks authorized for said mobile station received from the core network of said server network.

2. A method according to claim 1, characterized in that, in the case of networks including different types of cells in which different services or different radio access technologies are available, said list of authorized networks further indicates authorized services or radio access technologies for an authorized network.

3. A method according to claim 2, characterized in that the radio access technologies include second generation radio access technologies and third generation radio access technologies.

4. A method according to any one of claims 1 to 3, characterized in that the authorized networks and/or services or radio access technologies are a function of roaming agreements between operators.

5. A method according to any one of claims 1 to 4, characterized in that the authorized networks and/or services or radio access technologies are also a function of the user's type of contract.

6. A method according to any one of claims 1 to 5, characterized in that the authorized networks are classified in an order of preference for the user.

7. A method according to any one of claims 1 to 6, characterized in that said access network uses second generation radio access technologies.

8. A method according to claim 7, characterized in that, in a system of the GSM type, said access network is of the base station subsystem (BSS) type.

9. A method according to any one of claims 1 to 7, characterized in that said access network uses third generation technologies.

10. A method according to claim 9, characterized in that, in a system of the UMTS type, said access network is of the radio network subsystem (RNS) type.

11. A method according to any one of claims 1 to 10, characterized in that said optimized list is sent to the mobile station on a common channel.

12. A method according to any one of claims 1 to 10, characterized in that said optimized list is sent to the mobile station on a dedicated channel.

13. A mobile radio system including means for implementing a method according to any one of claims 1 to 12.

14. Mobile radio system equipment including means for implementing a method according to any one of claims 1 to 12.

15. A mobile station including means for implementing a method according to any one of claims 1 to 12.
